(19) United States
(12) Patent Application Publication
(10) Pub. No.: US 2026/0148319 A1
(43) Pub. Date: May 28, 2026

(54) ORDER SUPPORT DEVICE, ORDER SUPPORT METHOD, AND RECORDING MEDIUM

(71) Applicant: NEC Corporation, Tokyo (JP)

(72) Inventors: Toshiro MORITA, Tokyo (JP); Tomoko HASHIMOTO, Tokyo (JP); Tomohiro YAMAGUCHI, Tokyo (JP); Kazunobu KAGAWA, Tokyo (JP)

(73) Assignee: NEC Corporation, Tokyo (JP)

(21) Appl. No.: 19/371,010

(22) Filed: Oct. 28, 2025

(30) Foreign Application Priority Data
Nov. 27, 2024 (JP) 2024-206681

(51) Int. Cl. G06Q 50/12; G06Q 10/02

(52) U.S. Cl. CPC G06Q 50/12; G06Q 10/02

(57) ABSTRACT

An order support device includes an acquisition unit, an estimation unit, a prediction unit, and an output unit. The acquisition unit acquires reservation information regarding the number of store visitors to a restaurant. The estimation unit estimates a serving amount of a dish, based on the reservation information. The prediction unit predicts an amount of an ingredient to be ordered, based on the estimated serving amount of the dish. The output unit outputs a prediction result on the amount of the ingredient to be ordered.

This application is based upon and claims the benefit of priority from Japanese Patent Application No. 2024-206681, filed on Nov. 27, 2024, the disclosure of which is incorporated herein in its entirety by reference.

### TECHNICAL FIELD

The present disclosure relates to an order support device and the like.

### BACKGROUND ART

In a restaurant, for work of determining a type and amount of ingredients to be ordered, an information processing system that supports determination of the type and amount of ingredients may sometimes be used.

An ingredient order support system of JP 2022-121013 A specifies an insufficient ingredient from the number of reservations for each menu. Then, the ingredient order support system of JP 2022-121013 A calculates the quantity of an ingredient targeted for order placement, based on the insufficient ingredient.

### SUMMARY

An order support device according to an aspect of the present disclosure includes an acquisition unit that acquires reservation information regarding the number of store visitors to a restaurant, an estimation unit that estimates a serving amount of a dish, based on the reservation information, a prediction unit that predicts an amount of an ingredient to be ordered, based on the estimated serving amount of the dish, and an output unit that outputs a prediction result on the amount of the ingredient to be ordered.

An order support method according to an aspect of the present disclosure includes acquiring reservation information regarding the number of store visitors to a restaurant, estimating a serving amount of a dish, based on the reservation information, predicting an amount of an ingredient to be ordered, based on the estimated serving amount of the dish, and outputting a prediction result on the amount of the ingredient to be ordered.

A non-transitory recording medium according to an aspect of the present disclosure records a program for causing a computer to execute a process of acquiring reservation information regarding the number of store visitors to a restaurant, a process of estimating a serving amount of a dish, based on the reservation information, a process of predicting an amount of an ingredient to be ordered, based on the estimated serving amount of the dish, and a process of outputting a prediction result on the amount of the ingredient to be ordered.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of an order support system in the present disclosure;

FIG. 2 is a diagram illustrating an example of a configuration of an order support device in the present disclosure;

FIG. 3 is a diagram schematically illustrating an example of a display screen of an estimation result on amounts of dishes in the present disclosure;

FIG. 4 is a diagram schematically illustrating an example of a display screen of an estimation result on amounts of dishes in the present disclosure;

FIG. 5 is a diagram schematically illustrating an example of a display screen of a prediction result on order amounts of ingredients in the present disclosure;

FIG. 6 is a diagram schematically illustrating an example of a display screen of a prediction result on an order amount of an ingredient in the present disclosure;

FIG. 7 is a diagram schematically illustrating an example of a display screen of a prediction result on order amounts of ingredients in the present disclosure;

FIG. 8 is a diagram schematically illustrating an example of a display screen of a prediction result on order amounts of ingredients in the present disclosure;

FIG. 9 is a diagram illustrating an example of an operation flow of the order support device in the present disclosure;

FIG. 10 is a diagram illustrating an example of a configuration of an order support system in the present disclosure;

FIG. 11 is a diagram illustrating an example of a configuration of an order support device in the present disclosure;

FIG. 12 is a diagram illustrating an example of an operation flow of the order support device in the present disclosure; and

FIG. 13 is a diagram illustrating an example of a hardware configuration of the order support device in the present disclosure.

### EXAMPLE EMBODIMENT

### First Example Embodiment

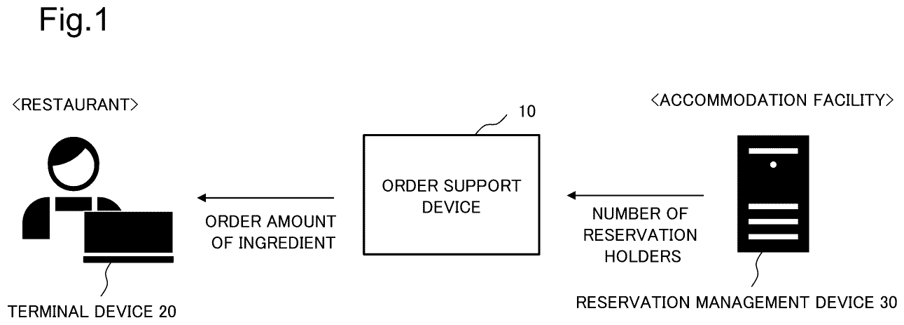

A first example embodiment of the present disclosure will be described in detail with reference to the drawings. FIG. 1 is a diagram illustrating an example of a configuration of an order support system. The order support system includes an order support device 10, a terminal device 20, and a reservation management device 30. The order support device 10 is connected to the terminal device 20 via, for example, a network. The order support device 10 is connected to the reservation management device 30 via, for example, a network. A plurality of terminal devices 20 and a plurality of reservation management devices 30 may be provided. The number of terminal devices 20 and the number of reservation management devices 30 can be set as appropriate.

The order support system predicts, for example, the amount of an ingredient to be ordered. The ingredient is, for example, a food used for cooking in a restaurant. For example, the ingredient to be ordered is a foodstuff to be prepared for use in a dish to be served to a customer in a restaurant, for example. That is, the ingredient to be ordered is, for example, a food to be ordered in advance for use in a dish to be served to a customer in a restaurant. A food to be served to a customer without being cooked in a restaurant may be included. For example, the ingredient may be a beverage or seasoning. The ingredient may include a material involved in cooking. The ingredient is not limited to the above.

The order support system estimates a serving amount of a dish in a restaurant, based on reservation information regarding the number of store visitors to the restaurant. The order support system then predicts the amount of an ingredient to be ordered, based on the estimated serving amount of the dish. The serving amount of a dish in a restaurant is, for example, the amount of a dish cooked by the restaurant in response to an order of a customer who has visited the restaurant. In a case where dishes are served in a buffet-style, the serving amount of a dish in a restaurant may be, for example, the amount of a dish cooked by the restaurant in order to serve the dish to customers.

The reservation information regarding the number of store visitors to a restaurant is, for example, reservation information that may be reflected in the number of store visitors to the restaurant. The number of store visitors to a restaurant affects, for example, the serving amount of a dish in the restaurant. Therefore, the reservation information regarding the number of store visitors to a restaurant is, for example, reservation information that can affect the amount of an ingredient necessary for serving dishes in the restaurant. The reservation information regarding the number of store visitors to a restaurant is, for example, information indicating details of a reservation to use a facility with the restaurant attached or details of a reservation to visit the restaurant. The details of the reservation include, for example, the number of people who use the facility or the number of people who use the restaurant. The details of the reservation are not limited to the above. A specific example of the reservation information regarding the number of store visitors to a restaurant will be described later.

For example, in a case where the reservation style does not include designation of a dish, it is difficult to estimate the amount of a dish that needs to be served in the restaurant. For this reason, in a case where the reservation style does not include designation of a dish, it may sometimes be difficult to appropriately deduce the amount of an ingredient to be ordered in the restaurant, for example. The order support system can easily predict the amount of an ingredient to be ordered, by estimating the serving amount of a dish in the restaurant, based on the reservation information regarding the number of store visitors to the restaurant, and predicting the amount of the ingredient to be ordered, based on the estimated serving amount of the dish.

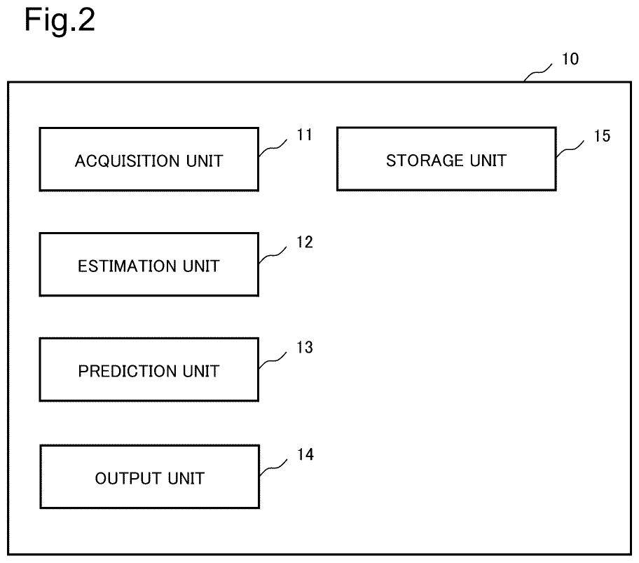

Here, a specific example of a configuration of the order support device 10 will be described. FIG. 2 illustrates an example of a configuration of the order support device 10. The order support device 10 includes an acquisition unit 11, an estimation unit 12, a prediction unit 13, and an output unit 14 as a basic configuration. The order support device 10 also includes, for example, a storage unit 15.

The acquisition unit 11 acquires the reservation information regarding the number of store visitors to a restaurant. The reservation information includes, for example, the number of people who have reservations at a facility with a restaurant attached or a restaurant. The number of people who have reservations is, for example, information indicating for how many people a reservation has been made to use the facility or the restaurant. For example, in a case where a restaurant is attached to a facility, the reservation information includes, for example, the number of people who will use the facility with the restaurant attached, by making a reservation. In a case where the reservation information includes the number of people who have reservations at the restaurant, the reservation information includes, for example, the number of persons who will eat and drink at the restaurant, by making a reservation.

The reservation information may be information regarding a reservation holder at a facility with a restaurant attached or a restaurant. The information regarding the reservation holder at a restaurant includes, for example, an attribute of the reservation holder.

The attribute of the reservation holder is, for example, information that can affect the contents of a dish that the reservation holder will eat and drink at the restaurant. For example, in a case where a restaurant is attached to a facility, the reservation information is, for example, information on an attribute of a reservation holder who has a reservation at the facility with the restaurant attached. The attribute of the reservation holder is, for example, information on one or multiple items of age, gender, nationality, occupation, annual income, and place of residence of the reservation holder. In a case where the reservation has been made for the whole group, the reservation holder is, for example, a person who made the reservation. In a case where the reservation has been made for the whole group, the reservation holder may be, for example, each person belonging to the group.

Examples of the facility include an accommodation facility, a bathing facility, a camping site, a conference hall, an exhibition hall, a theater, an art museum, a museum, a movie theater, a sports facility, an amusement park, and a theme park. The facility is not limited to the above. The phrase “with a restaurant attached” means, for example, that a restaurant is installed on the same site as the facility or on a site adjacent to the facility. The phrase “with a restaurant attached” may mean, for example, that a restaurant is installed in a range that allows a user of the facility to visit the restaurant, and the facility and the restaurant have a business relationship with each other.

In a case where the reservation information includes the number of people who have reservations at a facility with a restaurant attached, the reservation information may further include at least one of the number of people for each group, the scheduled time of arrival at the facility, the scheduled time of stay in the facility, the preference for dishes, the use record of the facility, the use record of the restaurant, and the physical constitution. The physical constitution is, for example, the physical constitution of each person included in the group. The physical constitution may be, for example, the physical constitutions of some persons included in the group. The physical constitution is, for example, a physical constitution relating to dietary restrictions. In a case where the reservation information includes the number of people who have reservations at a restaurant, the reservation information may further include at least one of the number of people for each group, the scheduled time of arrival at the restaurant, the preference for dishes, the use record of the restaurant, and the physical constitution.

In a case where the facility is an accommodation facility, the reservation information may further include, for example, at least one of the scheduled date and time of arrival, the number of consecutive nights, a reservation route, a room style, a room grade, an accommodation plan, and whether a meal ticket has been provided. The reservation route is, for example, information indicating through which route of a business reservation service, a travel agency, and a direct reservation a reservation has been made. For example, a difference in tendency of meals may arise between a case of an accommodation for business and a case of an accommodation for travel. The accommodation plan is, for example, information about a usage fee, a discount rate, additional services, and whether a meal is included. The reservation information may include whether a meal ticket has been issued.

In a case where the reservation information includes the number of people who have reservations at a restaurant, the reservation information may further include information indicating a style of a seat to be reserved at the restaurant. The style of the seat is, for example, information indicating classification of a counter seat, a table seat, a box seat, and a tatami room. The style of the seat may be information indicating a section where the seat is installed. For example, the style of the seat may be information indicating classification of a normal area and a private room. The normal area is, for example, an area in which a table and a chair are arranged on a customer seat floor and there is no partition between the tables. The style of the seat is not limited to the above.

In a case where the reservation information includes the number of people who have reservations at a restaurant, the reservation information may further include at least one piece of information on a medium used for the reservation, a purpose of the meal, and a reserved dish. The information on the medium used for the reservation may include information on whether a coupon in the reservation service has been given. The purpose of the meal is, for example, information indicating whether the meal is an ordinary meal, a reunion, a party with an acquaintance, a party with a business partner, a birthday party, a farewell party, or an anniversary greeting. The purpose of the meal is not limited to the above.

The acquisition unit 11 acquires, for example, the reservation information regarding the number of store visitors to a restaurant from reservation management device 30. The acquisition unit 11 may acquire the reservation information regarding the number of store visitors to the restaurant from the terminal device 20. The reservation information may be based on data of a use record in a member service. For example, the reservation information may be a use record of the restaurant of a member recorded in a restaurant introduction service. In this case, the acquisition unit 11 acquires the reservation information on the reservation holder from an information processing device managing the member service.

In a case where the serving amount of a dish used to estimate the amount of an ingredient to be ordered can be changed from the estimation result, the acquisition unit 11 acquires a changed value of the serving amount of the dish. For example, the acquisition unit 11 acquires the changed value of the serving amount of the dish from the terminal device 20. In a case where the amount of an ingredient to be ordered can be changed from the prediction result, the acquisition unit 11 acquires a changed value of the amount of the ingredient to be ordered. For example, the acquisition unit 11 acquires the changed value of the amount of the ingredient to be ordered, from the terminal device 20.

The estimation unit 12 estimates the serving amount of a dish, based on the reservation information. The estimation unit 12 estimates the serving amount of a dish in a restaurant, based on, for example, the number of people who have reservations at a facility with a restaurant attached or a restaurant. The estimation unit 12 may estimate the serving amount of a dish, based on the number of people who have reservations and the attribute of the reservation holder.

In a case where the restaurant is a restaurant attached to a facility, the estimation unit 12 estimates the serving amount of a dish in the restaurant, based on the reservation information on the facility, for example. For example, in a case where the restaurant is a restaurant attached to an accommodation facility, the serving amount of a dish in the restaurant is estimated based on the reservation information on the accommodation facility. For example, in a case where the restaurant is a restaurant attached to a facility, the estimation unit 12 estimates the serving amount of a dish in the restaurant, based on reservation information related to the number of persons staying in the facility at the date and time targeted for estimation of the serving amount of the dish in the restaurant, in the reservation information on the facility. For example, the estimation unit 12 estimates the serving amount of a dish in the restaurant, based on the number of people who have reservations for an accommodation on the day targeted for estimation of the serving amount of the dish. In a case where the serving amount of a dish at breakfast is estimated, the estimation unit 12 estimates the serving amount of the dish in the restaurant, based on, for example, the number of people who have reservations for an accommodation at night on the day before the day targeted for estimation of the serving amount of the dish.

The estimation unit 12 may estimate the serving amount of a dish, based on the number of people who have reservations and the attribute of the reservation holder. For example, the estimation unit 12 estimates the serving amount of a dish, based on the number of people who have reservations and one or multiple items of age, gender, nationality, occupation, annual income, and place of residence of the reservation holder. In a case where the reservation has been made for the whole group, the estimation unit 12 estimates the serving amount of a dish, using, for example, the attribute of a representative of the group, as the attribute of the reservation holder. In a case where the reservation has been made for the whole group, the estimation unit 12 may estimate the serving amount of a dish, using the attribute of each person belonging to the group, as the attribute of the reservation holder.

For example, the estimation unit 12 estimates the serving amount of a dish in a restaurant, using an estimation model. The estimation model is, for example, a machine learning model that estimates the serving amount of a dish, with the reservation information as an input. The estimation model is generated, for example, by learning a relationship between the reservation information, and the type of a served dish and the amount of each dish. For example, in a case where the reservation information includes the number of reservation holders, the estimation model is generated by learning a relationship between the number of reservation holders, and the type of a served dish and the amount of each dish. The estimation model is generated by deep learning using a neural network, for example.

A machine learning algorithm capable of estimating a reason for estimation may be used to generate the estimation model. For example, in a case where an estimation model is generated by deep learning using a neural network, the estimation model is generated as a machine learning model that extracts an item having a larger influence on an estimation result, as a reason for estimation, based on a change in a quantity of a dish in a case where data of each item is varied. For example, the estimation unit 12 varies the data of each item included in input data to the estimation model and extracts an item having a larger influence on an estimation result, as a reason for estimation.

A machine learning algorithm may be used based on factorized asymptotic Bayesian inference to generate the estimation model capable of estimating a reason for estimation. When learning is performed using a machine learning algorithm based on the factorized asymptotic Bayesian inference, cases are classified according to a rule in a decision tree format with the reservation information as input data, and a dish and the amount of the dish as ground truth data. Then, based on the decision tree, a machine learning model is generated using a linear model in which different explanatory variables are combined in each case. Thereafter, the machine learning model is generated by sequentially performing processes of optimization of a data case classification condition, generation of an estimation model by optimization of a combination of explanatory variables, and deletion of an unnecessary estimation model. In the estimation model generated by such a method of generating a machine learning model by a combination of different explanatory variables, the estimation result can be explained using a case classification condition having a strong influence on the estimation result, and accordingly, the explainability of the estimation result is improved.

In a case where the estimation result on the serving amount of a dish can be changed, optimization using a changed value of the serving amount of the dish may be performed on the estimation model. The estimation model is generated, for example, in a device outside the order support device 10. The estimation model may be generated by a learning means (not illustrated) in the order support device 10. The machine learning algorithm for generating the estimation model is not limited to the above.

The estimation unit 12 may estimate the serving amount of a dish by calculating the serving amount of the dish using a function for calculating the serving amount of the dish from the reservation information. The function for calculating the serving amount of a dish from the reservation information is, for example, a function having the reservation information as an explanatory variable and the serving amount of the dish as an objective variable. The function for calculating the serving amount of a dish from the reservation information is set for each dish, for example. The function for calculating the serving amount of a dish from the reservation information may be set for each category of dishes.

The estimation unit 12 may perform estimation by scoring the reservation information. The estimation unit 12 calculates the score of the reservation information by referring to a table in which the reservation information and the score are associated with each other. For example, the estimation unit 12 refers to a table in which the score and the amount of a dish are associated with each other to estimate the serving amount of the dish from the calculated score.

In a case where a plurality of restaurants is attached to a facility, the estimation unit 12 estimates the serving amount of a dish for each of the restaurants attached to the facility, for example. For example, it is assumed that three restaurants of a restaurant A, a restaurant B, and a restaurant C are installed in a facility. In this case, the estimation unit 12 estimates the serving amount of a dish in each of the restaurants A, B, and C, for example.

In a case where the serving amount of a dish is estimated for each restaurant attached to the facility, the estimation unit 12 may estimate the number of store visitors to each restaurant and estimate the serving amount of a dish for each restaurant, based on the estimated number of store visitors. For example, in a case where three restaurants of a restaurant A, a restaurant B, and a restaurant C are installed in a facility, the estimation unit 12 estimates the number of store visitors to each of the restaurants A, B, and C, for example. The estimation unit 12 then estimates the serving amount of a dish in each of the restaurants A, B, and C, based on the estimated number of store visitors, for example.

In a case where the reservation information includes information on whether a meal ticket has been provided, the estimation unit 12 may estimate the serving amount of a dish, based on the number of people who have reservations and the number of issued meal tickets. For example, a person who holds a meal ticket is highly likely to visit a store for a meal, but it may sometimes be difficult to predict whether a person who does not hold a meal ticket will visit a store. Therefore, by referring to the number of people who hold meal tickets and the number of people who do not hold a meal ticket among the number of people who have reservations, the accuracy of estimation of the serving amount of a dish may be improved.

In a case where the reservation information includes information indicating the style of a seat to be reserved in a restaurant, the estimation unit 12 estimates the serving amount of a dish, based on the number of people who have reservations and the information indicating the style of the seat. For example, it is assumed that three types of seats of a counter seat, a table seat, and a private room are installed in a restaurant. In this case, the estimation unit 12 estimates the serving amount of a dish, based on the number of people who have reservations and information on the reserved seat. For example, a difference in tendency of dishes to be ordered may arise between a person reserving a counter seat and a person reserving a private room. Therefore, the accuracy of estimation may be improved by estimating the serving amount of a dish using the information indicating the style of the seat.

The estimation unit 12 may estimate the serving amount of a dish, based on a constraint condition. For example, in a case where there is a dish for which a limited number is set, the estimation unit 12 may estimate the serving amount of each dish with the limited number as an upper limit for a dish for which the limited number is set. For example, in a case where a limited number of only 10 servings is set for a special Wagyu steak, in a case where demand over the limited number of 10 servings is expected, the estimation unit 12 predicts the serving amount of dishes in such a way that the serving amount of other beef steaks is increased. The estimation unit 12 may estimate the serving amount of a dish with a budget as a constraint condition. In this case, for example, the estimation unit 12 estimates a dish with which the store visitors can be served within the budget, and the serving amount of each dish. In a case where the serving amount of a dish is estimated based on the constraint condition, the estimation unit 12 estimates the amount of the dish, using, for example, a mathematical optimization algorithm.

The estimation unit 12 may estimate the serving amount of a dish further based on an event conducted in a facility with a restaurant attached or a restaurant. The estimation unit 12 may also estimate the serving amount of a dish further based on an event conducted around a restaurant. For example, the estimation unit 12 estimates the serving amount of a dish, using an estimation model that uses the presence or absence of an event to be conducted, as input data. Examples of the event conducted in a facility or around the facility include an exhibition, a lecture, a concert, a movie show, a seminar, a sports game, a school event, and a regional event. Examples of the event performed in a restaurant include a campaign based on a seasonal event and a campaign for a particular product. The event is not limited to the above.

The estimation unit 12 may estimate the serving amount of a dish further based on an external environment. For example, the estimation unit 12 may estimate the serving amount of a dish further based on at least one of the season, the time of day, the day of the week, the weather, the air temperature, whether a neighboring facility is open, and the traffic conditions. Whether a neighboring facility is open is, for example, information indicating whether a neighboring school or company is on an operating day. Whether a neighboring facility is open is not limited to the above. The traffic conditions include closing of a neighboring road or information on cancellation of a train or a bus. The traffic conditions are not limited to the above. The external environment is not limited to the above. For example, the estimation unit 12 estimates the serving amount of a dish, using an estimation model that uses the external environment as input data.

For example, the estimation unit 12 estimates the serving amount of a dish in accordance with an order cycle of an ingredient. For example, in a case where an ingredient is ordered at intervals of three days, the estimation unit 12 estimates, for example, the amount of a dish served in three days. The estimation unit 12 may estimate the serving amount of a dish in a cycle according to a period for which the amount of an ingredient to be ordered is predicted by the prediction unit 13. The estimation unit 12 may also estimate the serving amount of a dish for each day of the week. For example, the estimation unit 12 estimates the serving amount of a dish for each day of the week in one month. The period targeted for estimation of the serving amount of a dish can be set as appropriate.

The prediction unit 13 predicts the amount of an ingredient to be ordered, based on the estimated serving amount of a dish. For example, the prediction unit 13 predicts the amount of an ingredient to be ordered by calculating the amount of the ingredient to be used for each dish, using ingredient lists set for each dish. The ingredient list is, for example, a list in which ingredients used in a dish are associated with amounts used in the dish for one person. The amount used may be in units of an amount other than the amount for one person. For example, the amount used may be a weight of a dish or an amount of an ingredient used per plate. The unit of the amount of an ingredient to be used is not limited to the above. The ingredient list may further include information on one or multiple items of a price of the ingredient, a grade of the ingredient, an order unit, an amount per package, an expiration date, and an order destination of the ingredient in association with each ingredient.

For example, the prediction unit 13 predicts the amount of each ingredient by multiplying the amount indicated in the ingredient list by the amount of a dish. In a case where a same ingredient is used in a plurality of dishes, for example, the prediction unit 13 predicts the amount of the ingredient to be ordered by summing the amounts of the ingredient to be used in each of the dishes. The prediction unit 13 may also predict the amount of an ingredient to be ordered by adding a spare of the ingredient to the amount of the ingredient calculated from the ingredient list and the amount of a dish. The amount of spares of the ingredient is set based on, for example, at least one of the dish and the ingredient. The amount of spares of the ingredient is set, for example, in such a way that no stockout dish will arise. In a case where the expiration date of the ingredient is short or in a case where the ingredient is expensive, the amount of spares may be set to be small. The prediction unit 13 may also predict the amount of an ingredient to be ordered, based on a difference between the stock of the ingredient and the amount necessary for a dish.

In a case where a plurality of restaurants is attached to a facility, the prediction unit 13 predicts the amount of an ingredient to be ordered for each of the restaurants attached to the facility, for example. The prediction unit 13 may predict the sum value of the amounts of an ingredient to be used in two or more restaurants.

For example, the prediction unit 13 predicts the amount of an ingredient to be ordered in accordance with an order cycle of the ingredient. For example, in a case where an ingredient is ordered at intervals of three days, the prediction unit 13 predicts the amount of the ingredient to be ordered, based on a prediction result on the amount of a dish to be served in three days. The prediction unit 13 may predict the amount of an ingredient for a period different for each ingredient. For example, in a case where the order cycle of an ingredient A is three days and the order cycle of an ingredient B is seven days, the prediction unit 13 predicts the amount to be ordered for the ingredient A, based on a prediction result on the amount of a dish to be served in three days. The prediction unit 13 also predicts the amount to be ordered for the ingredient B, based on a prediction result on the amount of a dish to be served in seven days.

The prediction unit 13 may estimate the grounds for prediction of the order amount. For example, in a case where the order amount is different from a usual order amount, the prediction unit 13 estimates the grounds for prediction of the order amount. The fact that the order amount is different from a usual order amount means that, for example, the order amount for each ingredient is increased or decreased by a predetermined reference or more from an average order amount per one time for each ingredient. The prediction unit 13 estimates the serving amount of a dish having a larger influence on an increase or decrease in the order amount of an ingredient, as grounds for prediction of the order amount of the ingredient. The predetermined reference is set, for example, based on the magnitude of the influence on stock management. For example, in a case where an estimated value of the serving amount of assorted sashimi is higher than usual, the prediction unit 13 estimates, for example, that the serving amount of the assorted sashimi is higher than usual, as grounds for prediction of the order amount of tuna. In a case where the estimation model is a machine learning model capable of outputting the reason for the estimation result, the prediction unit 13 may estimate a reason for an estimation result on a dish to be served, as grounds for prediction.

The prediction unit 13 may change the amount of an ingredient to be ordered, based on a changed value of the prediction result of the amount of the ingredient to be ordered. For example, in a case where a changed value of the prediction result is acquired, the prediction unit 13 determines the acquired changed value, as the amount to be ordered for an ingredient of which the changed value has been acquired. For example, the prediction unit 13 determines the value of the prediction result, as the amount to be ordered for an ingredient of which the changed value has not been acquired.

The prediction result of the amount of an ingredient to be ordered is corrected, for example, by a person in charge of ordering the ingredient in a restaurant. For example, in a case where the number of employees is insufficient or a highly skilled employee is insufficient, the person in charge of ordering ingredients corrects the prediction result in such a way as to reduce the amount of a dish that is difficult to cope with. In a case where there is a dish that is desired to be intensively sold by performing a campaign, the person in charge of ordering ingredients corrects the prediction result in such a way that the amount of the dish that is desired to be intensively sold increases.

The output unit 14 outputs a prediction result on the amount of an ingredient to be ordered. The output unit 14 outputs, for example, an order amount for each ingredient. The output unit 14 may output the order amount of an ingredient for each order destination. For example, in a case of placing an order with three companies of a company A, a company B, and a company C, the output unit 14 may output the order amount of an ingredient for each order destination. For example, the order amount to the company A, the order amount to the company B, and the order amount to the company C are separately output. The output unit 14 may output the order amount of an ingredient for each order. For example, in a case where the order is placed for each day, the output unit 14 outputs the order amount of an ingredient for each day. The output unit 14 may output the reason for prediction of the order amount of an ingredient. The output unit 14 may output an input screen for inputting a changed value of the amount of an ingredient to be ordered.

The output unit 14 may output an estimation result on the serving amount of a dish. For example, the output unit 14 outputs a dish made with the ordered ingredients and the amount of the dish, for each order of an ingredient, based on the estimation result on the serving amount of the dish. The output unit 14 may output a reason for the estimation result on the serving amount of a dish. The output unit 14 may output an input screen for inputting a changed value of the serving amount of a dish. In a case where any of dishes is selected in the estimation result on the serving amount of the dishes, the output unit 14 may output a list of ingredients to be used in the selected dish.

The output unit 14 may output an ingredient with an order amount different from a usual order amount in an emphasized manner. Outputting in an emphasized manner means that the output is made with improved visibility as compared with that of other ingredients. For example, the output unit 14 outputs an ingredient with an order amount different from a usual order amount with at least one of a display color, a size of a character, a thickness of a character, and the presence or absence of an underline in a mode different from that of other ingredients. The mode of emphasizing an ingredient with an order amount different from a usual order amount is not limited to the above. The output unit 14 may output an ingredient with an order amount different from a usual order amount, using a plurality of levels of modes according to the magnitude of a difference from the usual order amount. For example, the output unit 14 outputs an ingredient having an increase or decrease from an average order amount per one time for each ingredient by a predetermined reference or more, in an emphasized manner. The output unit 14 may output a dish to be served in an amount different from a usual amount, in an emphasized manner.

The output unit 14 outputs the amount of an ingredient to be ordered, to the terminal device 20, for example. The output unit 14 outputs the serving amount of a dish to the terminal device 20, for example. The output unit 14 may output the amount of an ingredient to be ordered, to an ingredient order system (not illustrated).

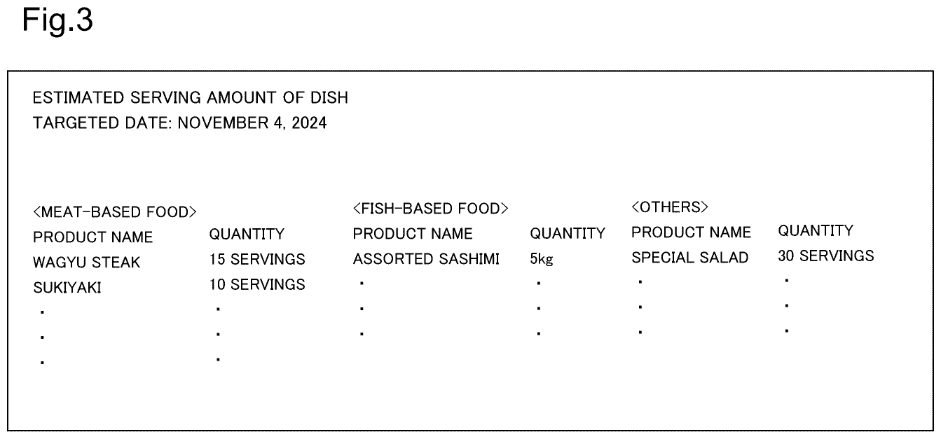

FIG. 3 depicts an example of a display screen that displays an estimation result on the serving amount of a dish. In the example of the display screen in FIG. 3, a date targeted for estimation of the serving amount of a dish is displayed. The targeted date is, for example, a date on which a dish is served in a restaurant. In the example of the display screen in FIG. 3, the dishes are categorized into “meat-based food”, “fish-based food”, and “others”. In the example of the display screen in FIG. 3, the dish names of dishes each belonging to one of the categories and the estimation results on the serving amounts of these dishes are displayed. The person in charge of ordering ingredients can grasp the estimation result on the serving amount of a dish by referring to the display screen as in FIG. 3, for example.

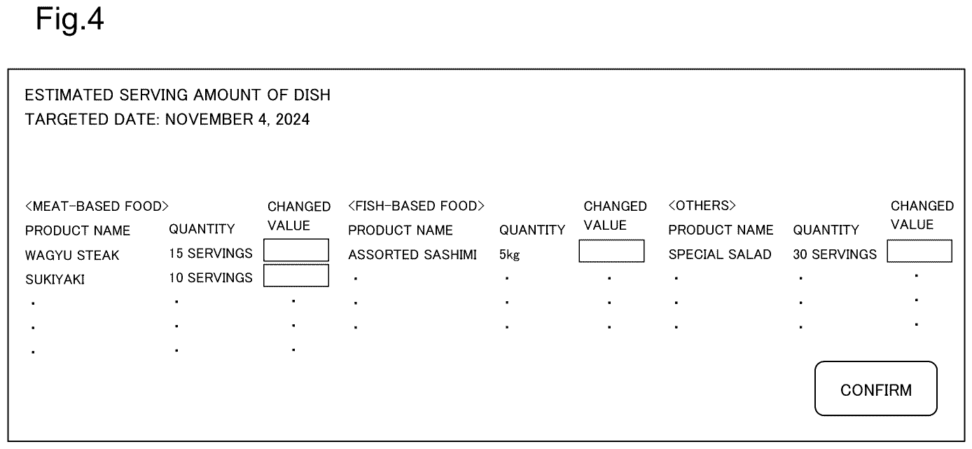

FIG. 4 depicts an example of a display screen for making an instruction to change the amount of a dish to be used for prediction of the amount of an ingredient to be ordered, in the estimation result on the serving amount of a dish. In the example of the display screen in FIG. 4, a date targeted for estimation of the serving amount of a dish is displayed. In the example of the display screen in FIG. 4, the dishes are categorized into “meat-based food”, “fish-based food”, and “others”. In the example of the display screen in FIG. 4, the dish names of dishes each belonging to one of the categories and the estimation results on the serving amounts of these dishes are displayed. In the example of the display screen in FIG. 4, an input field for inputting a changed value for changing the estimation result on the serving amount of a dish is displayed as “changed value”. In the example of the display screen in FIG. 4, a “confirm” button is displayed. In the example of the display screen in FIG. 4, the “confirm” button is a button for confirming the estimation result on the serving amount of a dish. In the example of the display screen in FIG. 4, for example, in a case where the “confirm” button is pressed with a changed value input, the value of the changed value is treated as the estimation result for a dish for which a changed value has been input. In the example of the display screen in FIG. 4, for a dish for which no changed value has been input, the value estimated by the estimation unit 12 is treated as the estimation result as it is.

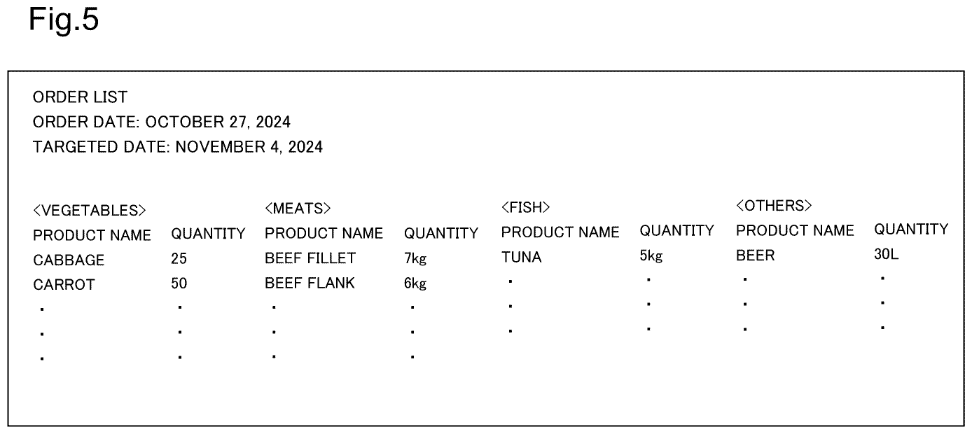

FIG. 5 illustrates an example of a display screen that displays a prediction result on the amount of an ingredient to be ordered. In the example of the display screen in FIG. 5, an order date that is a date on which ingredients are to be ordered is displayed. In the example of the display screen in FIG. 5, a date targeted for estimation of the serving amount of a dish is displayed. The order date is, for example, a date on which ingredients to be used in a dish on the targeted date are ordered. The targeted date is, for example, a date on which a dish is served in a restaurant. In the example of the display screen in FIG. 5, the ingredients to be ordered are categorized into “vegetables”, “meats”, “fish”, and “others”. In the example of the display screen in FIG. 5, the names of ingredients each belonging to one of the categories and the prediction results on the order amounts of these ingredients are displayed.

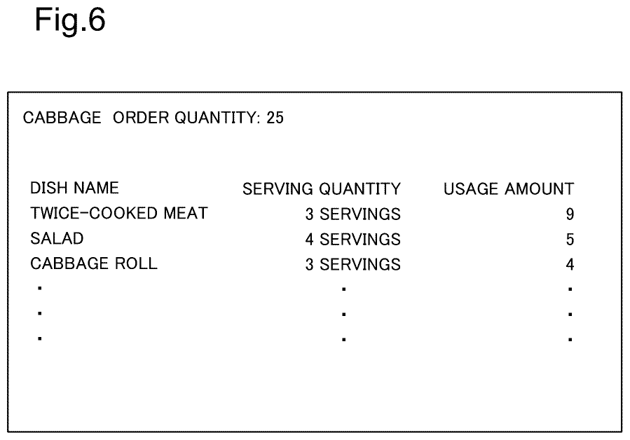

FIG. 6 depicts an example of a display screen that displays a dish in which an ingredient to be ordered is to be used. In the example of the display screen in FIG. 6, “dish name”, “serving quantity”, and “usage amount” are displayed. In the example of the display screen in FIG. 6, “dish name” denotes a name of a dish in which the ingredient to be ordered is to be used. In the example of the display screen in FIG. 6, “serving quantity” denotes an estimation result on the amount to be served for each dish. In the example of the display screen in FIG. 6, “usage amount” denotes the amount of the ingredient necessary for making the amount estimated as the serving quantity for each dish. That is, in the example of the display screen in FIG. 6, “usage amount” denotes the amount of the ingredient to be ordered to make a dish by an amount estimated as the amount to be served for each dish.

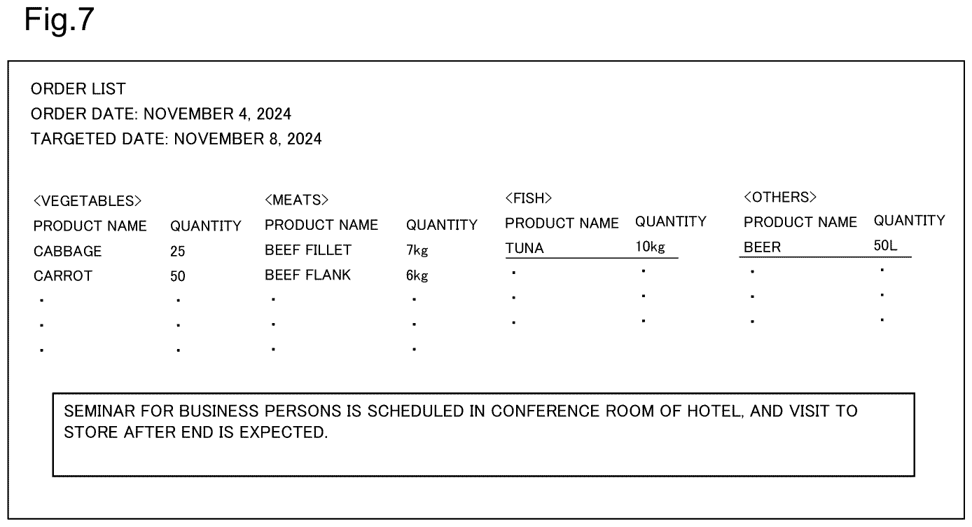

FIG. 7 depicts an example of a display screen that displays a reason for prediction in addition to the prediction result on the amount of an ingredient to be ordered. In the example of the display screen in FIG. 7, an order date that is a date on which ingredients are to be ordered is displayed. In the example of the display screen in FIG. 7, a date targeted for estimation of the serving amount of a dish is displayed. In the example of the display screen in FIG. 7, the ingredients to be ordered are categorized into “vegetables”, “meats”, “fish”, and “others”. In the example of the display screen in FIG. 7, the names of ingredients each belonging to one of the categories and the prediction results on the order amounts of these ingredients are displayed.

In the example of the display screen in FIG. 7, an ingredient with an amount different from a usual amount, among the ingredients to be ordered, is displayed in an emphasized manner. In the example of the display screen in FIG. 7, “tuna” and “beer” are underlined because an amount larger than a usual amount needs to be ordered. In the example of the display screen in FIG. 7, a reason for prediction of the amount of an ingredient to be ordered is displayed. In the example of the display screen in FIG. 7, a sentence “a seminar for business persons is scheduled in a conference room of a hotel, and a visit to the store after the end is expected.” is displayed as a reason for prediction of the amount of an ingredient to be ordered. In the example of the display screen in FIG. 7, for example, it is indicated that the reason why an amount larger than a usual amount needs to be ordered for “tuna” and “beer” is a seminar for business persons in a conference room of a hotel. In this case, for example, “tuna” and “beer” are indicated as an ingredient and a beverage used for dishes preferred by business persons.

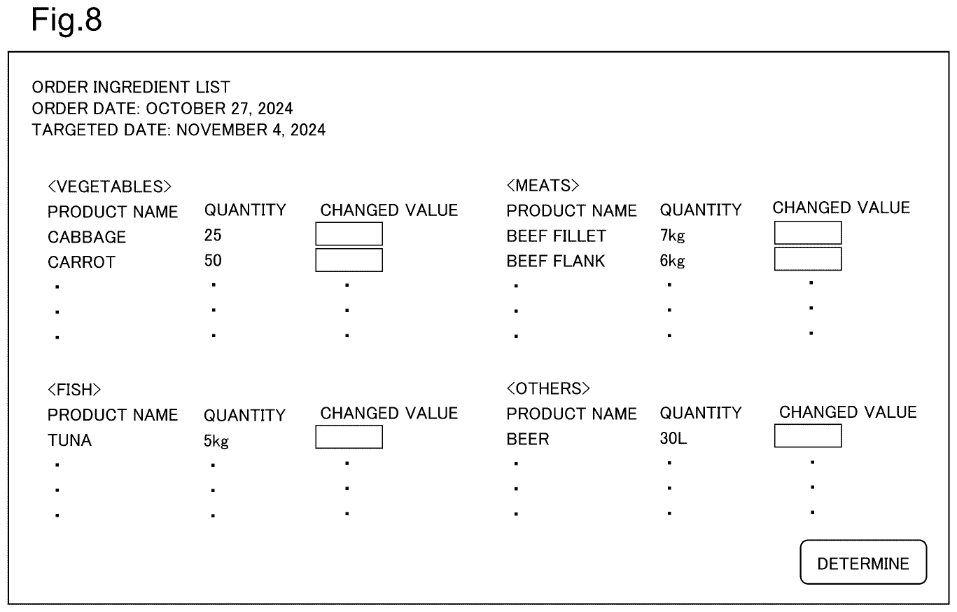

FIG. 8 depicts an example of a display screen for making an instruction to change the amount of an ingredient to be ordered, in the prediction result on the amount of an ingredient to be ordered. In the example of the display screen in FIG. 8, an order date that is a date on which ingredients are to be ordered is displayed. In the example of the display screen in FIG. 8, a date targeted for estimation of the serving amount of a dish is displayed. In the example of the display screen in FIG. 8, “product name” and “quantity” are displayed. In the example of the display screen in FIG. 8, an input field for inputting a changed value for changing the amount of an ingredient to be ordered, from the prediction value, is displayed as “changed value”. In the example of the display screen in FIG. 8, a “determine” button is displayed. In the example of the display screen in FIG. 8, the “determine” button is a button for confirming the amount of an ingredient to be ordered. In the example of the display screen in FIG. 8, for example, in a case where the “determine” button is pressed with a changed value input, the changed value is determined as the amount of the ingredient to be ordered for the ingredient for which the changed value has been input. In the example of the display screen in FIG. 8, for an ingredient for which no changed value has been input, the prediction value is determined as the amount of the ingredient to be ordered as it is.

The storage unit 15 retains, for example, information regarding a process of predicting the order amount of an ingredient. The storage unit 15 retains, for example, the reservation information regarding the number of store visitors to a restaurant. The storage unit 15 retains, for example, an estimation result on the serving amount of a dish. The storage unit 15 retains, for example, a prediction result on the amount of an ingredient to be ordered. The storage unit 15 retains, for example, the estimation model. The estimation model may be retained in a storage means other than the storage unit 15.

The terminal device 20 is, for example, an information processing device used by a person in charge of ordering ingredients in a restaurant. For example, the terminal device 20 acquires a prediction result on the order amount of an ingredient from the output unit 14 of the order support device 10. The terminal device 20 then outputs the prediction result on the order amount of the ingredient to a display device (not illustrated), for example. The prediction result on the order amount of the ingredient may include a reason for prediction. In a case where the prediction result including the input field for the changed value of the order amount of the ingredient is acquired, the terminal device 20 acquires, for example, a changed value of the order amount of the ingredient input with an instruction by the person in charge. The terminal device 20 then outputs the changed value of the order amount of the ingredient to the acquisition unit 11 of the order support device 10, for example.

For example, the terminal device 20 acquires an estimation result on the serving amount of a dish from the output unit 14 of the order support device 10. The terminal device 20 then outputs the estimation result on the serving amount of the dish, for example, to a display device (not illustrated). The estimation result on the serving amount of the dish may include a reason for estimation. In a case where the estimation result including the input field for the changed value of the serving amount of the dish is acquired, the terminal device 20 acquires, for example, a changed value of the serving amount of the dish input with an instruction by the person in charge. The terminal device 20 then outputs the changed value of the serving amount of the dish to the acquisition unit 11 of the order support device 10, for example.

As the terminal device 20, for example, a personal computer, a tablet computer, a smartphone, or a smartwatch can be used. The information processing device used for the terminal device 20 is not limited to the above.

For example, the reservation management device 30 retains the reservation information regarding the number of store visitors to a restaurant. For example, the reservation management device 30 outputs the reservation information regarding the number of store visitors to the restaurant to the acquisition unit 11. In a case where the reservation information regarding the number of store visitors to the restaurant is reservation information on a facility, the reservation management device 30 retains the reservation information on the facility, for example. For example, in a case where the facility is an accommodation facility, the reservation management device 30 retains information on the reservation holder for an accommodation, as the reservation information regarding the number of store visitors to the restaurant. For example, in a case where the reservation information is information on the restaurant, the reservation management device 30 retains information on the reservation holder at the restaurant, as the reservation information regarding the number of store visitors to the restaurant.

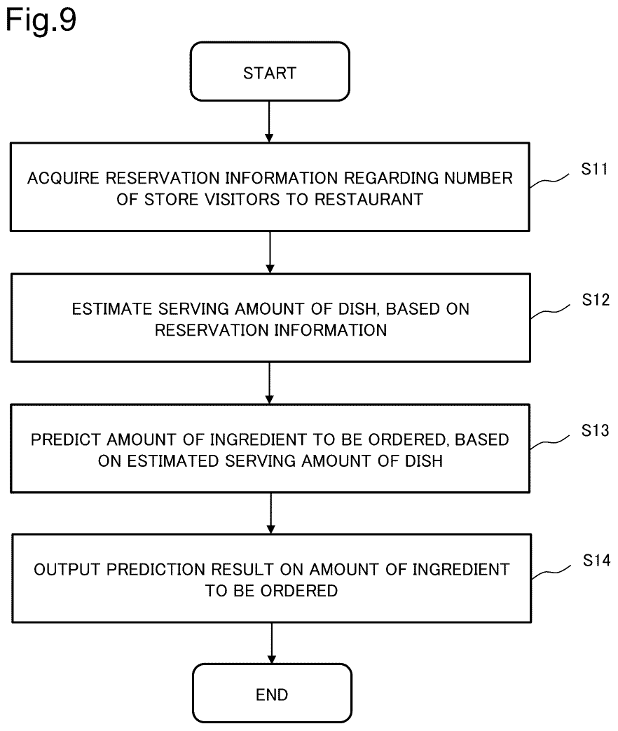

A process in which the order support device 10 predicts the amount of an ingredient to be ordered will be described. FIG. 9 depicts an example of an operation flow in a process in which the order support device 10 predicts the amount of an ingredient to be ordered.

The acquisition unit 11 acquires the reservation information regarding the number of store visitors to a restaurant (step S11). The acquisition unit 11 acquires the reservation information regarding the number of store visitors to the restaurant, for example, from the terminal device 20.

When the reservation information is acquired, the estimation unit 12 estimates the serving amount of a dish, based on the reservation information (step S12).

When the serving amount of the dish is estimated, the prediction unit 13 predicts the amount of an ingredient to be ordered, based on the serving amount of the dish estimated by the estimation unit 12 (step S13).

When the amount of the ingredient to be ordered is predicted, the output unit 14 outputs a prediction result on the amount of the ingredient to be ordered (step S14). The output unit 14 outputs the prediction result on the amount of the ingredient to be ordered, for example, to the terminal device 20.

Each process in the order support device 10 may be executed in a distributed manner in a plurality of information processing devices connected via a network. For example, the process in the estimation unit 12 and the process in the prediction unit 13 may be performed in different information processing devices. Which information processing device performs which process in the order support device 10 can be set as appropriate for each process.

The order support device 10 estimates the serving amount of a dish, based on the reservation information regarding the number of store visitors to a restaurant. The order support device 10 then predicts the amount of an ingredient to be ordered, based on the estimated serving amount of the dish. As described above, by predicting the amount of an ingredient to be ordered based on the serving amount of a dish predicted from the reservation information regarding the number of store visitors to a restaurant, the order support device 10 can easily predict the amount of the ingredient to be ordered.

For example, in a case where the reservation information is reservation information on a facility with a restaurant attached, the order support device 10 estimates the serving amount of a dish, based on the reservation information on the facility, and predicts the amount of an ingredient to be ordered, based on the estimation result. By predicting the amount of an ingredient to be ordered in this manner, the order support device 10 can appropriately predict the amount of the ingredient to be ordered even if, for example, there is no direct information about the number of store visitors to the restaurant. For example, in a case where the reservation information includes the number of store visitors to the restaurant, the order support device 10 can appropriately predict the amount of an ingredient to be ordered, in a case where the store visitors reserve no dish.

By outputting a reason for prediction of the amount of an ingredient to be ordered, the order support device 10 can facilitate verification of validity of the prediction result, for example. Therefore, for example, the person in charge of ordering ingredients with reference to the prediction result can determine the order amount of an ingredient by verifying the validity of the prediction result. By outputting the estimation result on the serving amount of a dish, the order support device 10 can easily verify the validity of the prediction result about the order amount of an ingredient, for example. By acquiring a changed value of the estimation result on the serving amount of a dish and predicting the amount of an ingredient to be ordered based on the changed value, the order support device 10 can appropriately predict the amount of the ingredient to be ordered in a case where it is desired to provisionally increase or decrease the serving amount of the dish according to the situation, for example.

### Second Example Embodiment

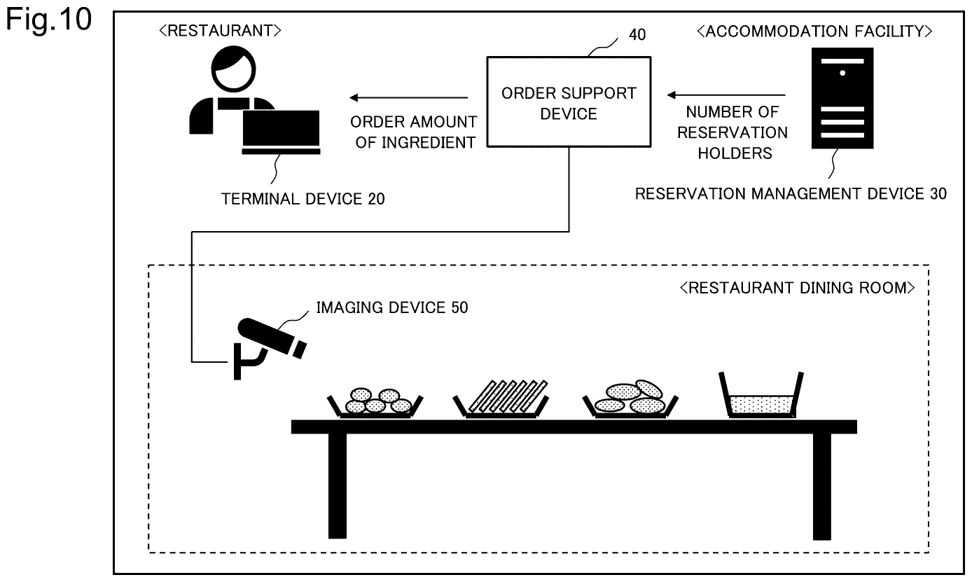

A second example embodiment of the present disclosure will be described in detail with reference to the drawings. FIG. 10 is a diagram illustrating an example of a configuration of an order support system. The order support system includes an order support device 40, a terminal device 20, a reservation management device 30, and an imaging device 50. The order support device 40 is connected to the terminal device 20 via, for example, a network. The order support device 40 is connected to the reservation management device 30 via, for example, a network. The order support device 40 is connected to the imaging device 50 via, for example, a network. A plurality of terminal devices 20, a plurality of reservation management devices 30, and a plurality of imaging devices 50 may be provided. The number of terminal devices 20, the number of reservation management devices 30, and the number of imaging devices 50 can be set as appropriate. The functions of the terminal device 20 and the reservation management device 30 are, for example, similar to the functions of the terminal device 20 and the reservation management device 30 of the first example embodiment.

The order support system of the present example embodiment estimates the order amount of an ingredient, based on a remaining amount of a dish served in a restaurant, for example. For example, the order support system detects a remaining amount of a dish from a video obtained by imaging a plate of the dish served in a buffet-style by using the imaging device 50. The order support system then estimates the serving amount of the dish, based on, for example, the reservation information regarding the number of store visitors to the restaurant and the detected remaining amount of the dish. The remaining amount of the dish may be detected by, for example, a weight sensor installed in a portion where the plate is placed. How to detect the remaining amount of the dish can be set as appropriate.

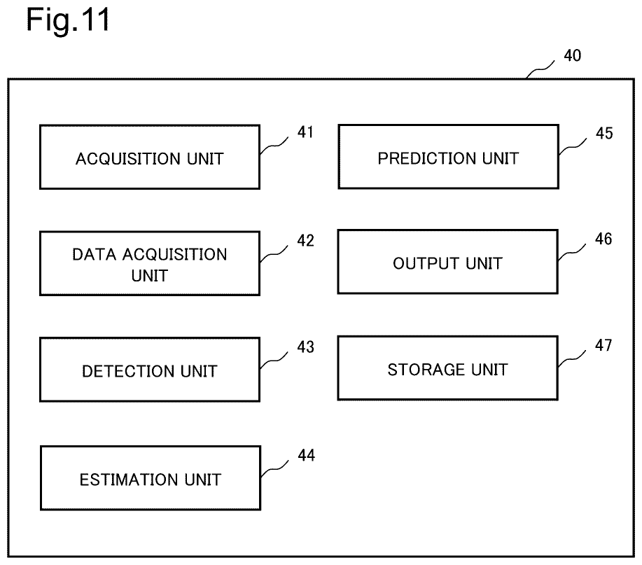

Here, a specific example of a configuration of the order support device 40 will be described. FIG. 11 illustrates an example of a configuration of the order support device 40. The order support device 40 includes, for example, an acquisition unit 41, a data acquisition unit 42, a detection unit 43, an estimation unit 44, a prediction unit 45, an output unit 46, and a storage unit 47. The acquisition unit 41 and the output unit 46 have functions similar to those of the acquisition unit 11 and the output unit 14 of the first example embodiment.

The data acquisition unit 42 acquires, for example, a video obtained by imaging a plate of a dish served in a buffet-style. For example, the data acquisition unit 42 acquires the video obtained by imaging the plate of the dish, from the imaging device 50. The data acquisition unit 42 may acquire the video obtained by imaging the plate of the dish, via a storage medium retaining the video obtained by imaging the plate of the dish. The video may be a moving image or a still image. For example, in a case where a weight sensor is used instead of the imaging device 50, the data acquisition unit 42 acquires a measurement result on the weight from the weight sensor.

The detection unit 43 detects, for example, a remaining amount of a dish. The detection unit 43 may detect the remaining amount of the dish, based on the amount of the served dish. For example, the detection unit 43 detects the remaining amount of each dish. The detection unit 43 detects, for example, the remaining amount in a case where the plate of the dish is replaced or removed. The amount of the served dish is, for example, the amount of the dish taken from the plate for serving the dish by the visiting customers to the restaurant. The detection unit 43 detects, for example, the remaining amount of the dish served in a buffet-style.

For example, the detection unit 43 detects the remaining amount of the dish, using a detection model. The detection model is, for example, a machine learning model that detects the remaining amount of the dish from a video obtained by imaging the plate of the dish, using an image recognition technique. The detection model is generated, for example, by learning a relationship between a video obtained by imaging a plate of a dish and a remaining amount. The detection model may be generated for each type of dish. The detection model is generated by deep learning using a neural network, for example. The machine learning algorithm for generating the detection model is not limited to the above. The detection model is generated, for example, in a device outside the order support device 40. The detection model may be generated by a learning means (not illustrated) in the order support device 40.

In a case where a weight sensor is used instead of the imaging device 50, the detection unit 43 detects the remaining amount of the dish from a measurement value of the weight sensor, for example. In this case, for example, the detection unit 43 detects the remaining amount of the dish, based on the weight of the plate alone and the measurement value of the weight. For example, the detection unit 43 detects the remaining amount of the dish by subtracting the weight of the plate alone from the maximum value of the measurement value of the weight. The weight of the plate alone is input by, for example, a person in charge of ordering ingredients with reference to a prediction result of the order support device 40.

For example, the estimation unit 44 estimates the serving amount of a dish, based on the reservation information regarding the number of store visitors to a restaurant and a detection result on the remaining amount of the dish. For example, the estimation unit 44 estimates the serving amount of the dish with the reservation information regarding the number of store visitors to the restaurant and the detection result on the remaining amount of the dish as inputs to the estimation model. In this case, the estimation model is generated by learning a relationship between the reservation information regarding the number of store visitors to the restaurant and the remaining amount of the dish, and the serving amount of the dish. The estimation model is generated by deep learning using a neural network, for example. The machine learning algorithm for generating the estimation model is not limited to the above.

As the remaining amount of the dish, for example, a result detected in a predetermined period is used. The length of the predetermined period is set to be, for example, the same as the length of the period for which the order amount of an ingredient is predicted. For example, the length of the predetermined period may be set to be substantially the same as the length of the period for which the order amount of an ingredient is predicted. For example, in a case where the order amount of an ingredient to be used from Monday to Sunday of the next week is predicted on Saturday, the length of the predetermined period is set to one week. For example, the estimation unit 44 estimates the serving amount of a dish, using, as an input to the estimation model, the remaining amount of the dish for one week preceding the day before the day for which the prediction is performed.

The estimation unit 44 may correct the estimated value of the serving amount of a dish estimated based on the reservation information regarding the number of store visitors to the restaurant, based on the remaining amount of the dish. For example, the estimation unit 44 estimates the serving amount of a dish, based on the reservation information regarding the number of store visitors to the restaurant, similarly to the estimation unit 12 of the first example embodiment. The estimation unit 44 then corrects the estimated value of the serving amount of the dish, based on the remaining amount of the dish, for example.

For example, in a case where the remaining amount of the dish is larger than a reference value, the estimation unit 44 corrects the estimated value in such a way that the larger the difference between the remaining amount of the dish and the reference value, the smaller the estimated value of the serving amount of the dish. For example, in a case where the remaining amount of the dish is smaller than the reference value, the estimation unit 44 corrects the estimated value in such a way that, for example, the larger the difference between the remaining amount of the dish and the reference value, the lager the estimated value of the serving amount of the dish. In a case where the prediction result on the amount of an ingredient to be ordered is corrected based on the remaining amount of the dish in the estimation unit 44, the estimation unit 44 estimates the amount of the ingredient to be ordered, similarly to the estimation unit 12 of the first example embodiment, for example.

The prediction unit 45 has a function similar to that of the prediction unit 13 of the first example embodiment, for example. That is, for example, the prediction unit 45 predicts the amount of an ingredient to be ordered, based on the estimation result on the serving amount of a dish estimated by the estimation unit 44. The prediction unit 45 may predict a correction value of the amount of an ingredient to be ordered, based on the detection result on the remaining amount of a dish.

In a case where the estimation unit 44 has estimated the serving amount of a dish similarly to the first example embodiment, the prediction unit 45 predicts the correction value of the amount of an ingredient to be ordered, based on, for example, the detection result on the remaining amount of the dish. The estimation of the serving amount of a dish performed similarly to the first example embodiment is, for example, estimation of the serving amount of a dish performed without considering the detection result on the remaining amount of the dish. For example, the prediction unit 45 estimates the order amount of an ingredient, based on the serving amount of a dish estimated without considering the remaining amount of the dish similarly to the first example embodiment. The prediction unit 45 then predicts, for example, the correction value of the order amount of the ingredient, based on the detection result on the remaining amount of the dish.

In a case where it is focused to suppress the disposal amount, for example, in a case where the remaining amount of a dish is equal to or more than a reference, the prediction unit 45 predicts the correction value of the order amount of an ingredient in such a way that the order amount of the ingredient decreases. In a case where it is focused to ensure that no stockout dish will arise, for example, in a case where the remaining amount of a dish is less than a reference, the prediction unit 45 predicts the correction value of the order amount of an ingredient in such a way that the order amount of the ingredient increases.

For example, the imaging device 50 images a plate of a dish put on a table in order to serve the dish to a visiting customer. The imaging device 50 then outputs a video obtained by imaging the plate of the dish, to the order support device 40, for example. The imaging device 50 may be installed in such a way as to image the plate of the dish from a lateral direction. For example, the imaging device 50 is installed in such a way as to image the plate of the dish from above. For example, the imaging device 50 is installed in such a way that all the plates put on the table can be imaged. The imaging device 50 may be installed in such a way as to be able to image a plate targeted for prediction of the order amount of an ingredient, among plates put on the table. For example, a plurality of imaging devices 50 may be installed in such a way that images can be captured for each plate of the dish. For example, a plurality of imaging devices 50 may be installed in such a way that images can be captured in units of multiple plates of dishes.

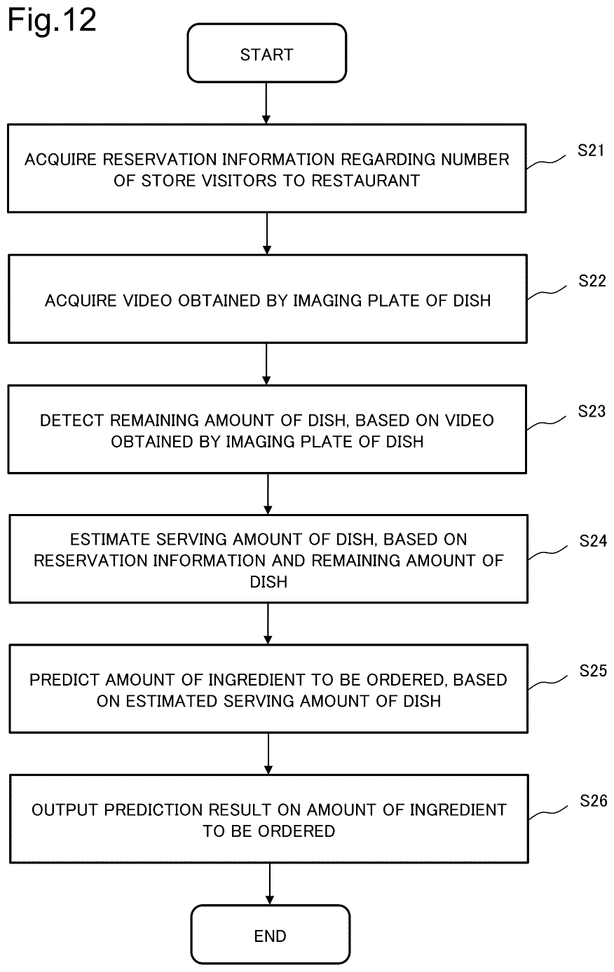

A process in which the order support device 40 predicts the order amount of an ingredient will be described. FIG. 12 depicts an example of an operation flow in a process in which the order support device 40 predicts the order amount of an ingredient.

For example, the acquisition unit 41 acquires the reservation information regarding the number of store visitors to a restaurant (step S21). The acquisition unit 41 acquires, for example, the reservation information regarding the number of store visitors to the restaurant from the terminal device 20.

For example, the data acquisition unit 42 acquires a video obtained by imaging a plate of a dish (step S22). For example, the data acquisition unit 42 acquires the video obtained by imaging the plate of the dish, from the imaging device 50.

When the video obtained by imaging the plate of the dish is acquired, the detection unit 43 detects the remaining amount of the dish, based on the video obtained by imaging the plate of the dish (step S23).

When the remaining amount of the dish is detected, the estimation unit 44 estimates the serving amount of the dish, based on the reservation information and the detected remaining amount of the dish (step S24).

When the serving amount of the dish is predicted, the prediction unit 45 predicts the amount of an ingredient to be ordered, based on the serving amount of the dish estimated by the estimation unit 44 (step S25).

When the amount of the ingredient to be ordered is predicted, the output unit 46 outputs a prediction result on the predicted amount of the ingredient to be ordered (step S26). The output unit 46 outputs, for example, the prediction result on the amount of the ingredient to be ordered, to the terminal device 20.

For example, the order support device 40 estimates the serving amount of a dish, based on the reservation information regarding the number of store visitors to a restaurant and a detection result on the remaining amount of the dish. The order support device 40 then predicts the amount of an ingredient to be ordered, for example, based on an estimation result on the serving amount of the dish. As described above, by predicting the amount of an ingredient to be ordered based on the reservation information regarding the number of store visitors to a restaurant and a detection result on the remaining amount of a dish, the order support device 40 can easily predict the amount of the ingredient to be ordered. With such a configuration, the order support device 40 can improve the accuracy of prediction of the amount of an ingredient to be ordered, for example.

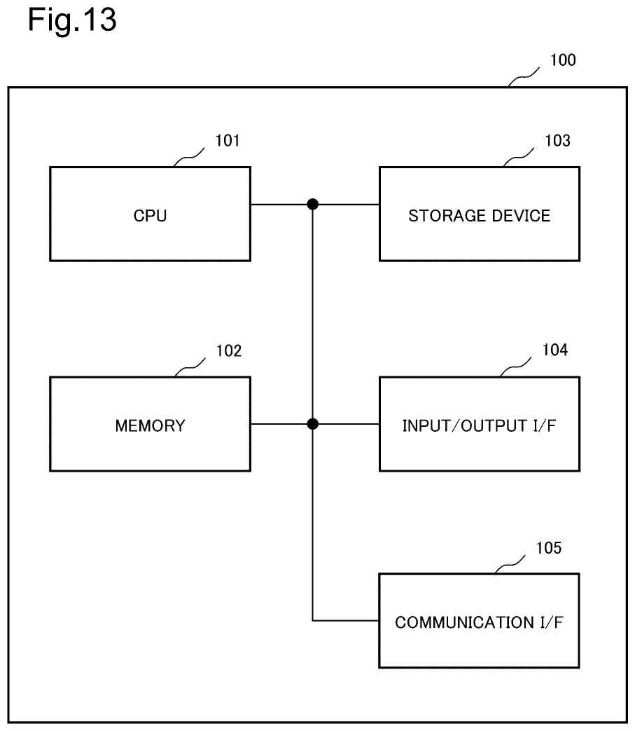

Each process in the order support device 10 and the order support device 40 can be implemented by executing a computer program on a computer. FIG. 13 illustrates an example of a configuration of a computer 100 that executes a computer program for executing each process in the order support device 10 and the order support device 40. The computer 100 includes a central processing unit (CPU) 101, a memory 102, a storage device 103, an input/output interface (I/F) 104, and a communication I/F 105.

The CPU 101 reads and executes the computer program for executing each process from the storage device 103. The CPU 101 may be constituted by a combination of a plurality of CPUs. The CPU 101 may be constituted by a combination of a CPU and another type of processor. For example, the CPU 101 may be constituted by a combination of a CPU and a graphics processing unit (GPU). The memory 102 is constituted by a dynamic random access memory (DRAM) or the like and temporarily stores the computer program executed by the CPU 101 and data being processed. The storage device 103 stores the computer program executed by the CPU 101. The storage device 103 is constituted by, for example, a non-volatile semiconductor storage device. As the storage device 103, another storage device such as a hard disk drive may be used. The input/output I/F 104 is an interface that accepts an input and outputs a display screen and the like. The communication I/F 105 is an interface that transmits and receives data to and from the terminal device 20, the reservation management device 30, the imaging device 50, and other information processing devices. The terminal device 20 and the reservation management device 30 can also be configured similarly to the computer 100.

The computer program used to execute each process can also be distributed by being stored in a computer-readable recording medium that non-transitorily records data. For example, a magnetic tape for data recording or a magnetic disk such as a hard disk can be used as the recording medium. An optical disc such as a compact disc read only memory (CD-ROM) can also be used as the recording medium. A non-volatile semiconductor storage device may be used as the recording medium.

In a restaurant, for example, the order amount of ingredients is determined by presuming the number of visiting customers. Meanwhile, the number of visiting customers may vary due to various factors. For example, if the tendency of dishes ordered by visiting customers can change, the ingredients that need to be ordered can also change. For this reason, a person in charge of ordering ingredients in a restaurant needs to appropriately determine the type and amount of ingredients to be ordered, according to the number of visiting customers and the customer class. For such work of determining the type and amount of ingredients to be ordered, an information processing system that supports determination of the type and amount of ingredients may sometimes be used.

An ingredient order support system of JP 2022-121013 A specifies an insufficient ingredient from the number of reservations for each menu. Then, the ingredient order support system of JP 2022-121013 A calculates the quantity of an ingredient targeted for order placement, based on the insufficient ingredient.

In the technique described in JP 2022-121013 A, it may sometimes be difficult to predict an appropriate amount of an ingredient to be ordered.

In order to solve the above problem, an object of the present disclosure is to provide an order support device and the like capable of easily predicting an appropriate amount of an ingredient to be ordered.

According to the present disclosure, it is possible to an appropriate amount of an ingredient to be ordered can be easily predicted.

Some or all of the above example embodiments may be described as the following Supplementary Notes, but are not limited to the following.

### Supplementary Note 1

An order support device including:
an acquisition unit that acquires reservation information regarding a number of store visitors to a restaurant;
an estimation unit that estimates a serving amount of a dish, based on the reservation information;
a prediction unit that predicts an amount of an ingredient to be ordered, based on the estimated serving amount of the dish; and
an output unit that outputs a prediction result on the amount of the ingredient to be ordered.

### Supplementary Note 2

The order support device according to Supplementary Note 1, in which
the reservation information includes a number of people who have reservations at a facility with the restaurant attached or a number of people who have reservations at the restaurant, and
the estimation unit estimates the serving amount of the dish, based on the number of people who have reservations.

### Supplementary Note 3

The order support device according to Supplementary Note 2, in which
the reservation information further includes an attribute of a reservation holder at the facility with the restaurant attached or the restaurant, and
the estimation unit estimates the serving amount of the dish, based on the number of people who have reservations and the attribute of the reservation holder.

### Supplementary Note 4

The order support device according to any one of Supplementary Notes 1 to 3, in which
the reservation information includes a number of people who have reservations at a facility with the restaurant attached, and further includes at least one of a number of people for each group, a scheduled time of arrival at the facility, scheduled time of stay in the facility, a preference for dishes, a use record of the restaurant, and a physical constitution.

### Supplementary Note 5

The order support device according to Supplementary Note 4, in which
the estimation unit estimates the serving amount of the dish for each restaurant attached to the facility.

### Supplementary Note 6

The order support device according to Supplementary Note 5, in which
the prediction unit predicts the amount of the ingredient to be ordered, for each restaurant attached to the facility.

### Supplementary Note 7

The order support device according to Supplementary Note 2 or 3, in which
the reservation information further includes information indicating a style of a seat to be reserved in the restaurant, and
the estimation unit estimates the serving amount of the dish, based on the number of people who have reservations and the information indicating the style of the seat.

### Supplementary Note 8

The order support device according to any one of Supplementary Notes 1 to 7, in which
the estimation unit estimates the serving amount of the dish, further based on a detection result on a remaining amount of the dish.

### Supplementary Note 9

The order support device according to any one of Supplementary Notes 1 to 7, in which
the estimation unit corrects an estimated value of the serving amount of the dish, based on a detection result on a remaining amount of the dish served in a buffet-style.

### Supplementary Note 10

The order support device according to Supplementary Note 8, further including
a detection unit that detects the remaining amount of the dish served in a buffet-style, in which
the estimation unit estimates the serving amount of the dish, based on the detected remaining amount of the dish.

### Supplementary Note 11

The order support device according to any one of Supplementary Notes 1 to 7, in which
the prediction unit predicts the amount of the ingredient to be ordered, further based on a detection result on a remaining amount of the ingredient.

### Supplementary Note 12

The order support device according to any one of Supplementary Notes 1 to 11, in which
the estimation unit estimates the serving amount of the dish, further based on an event conducted in a facility with the restaurant attached or the restaurant, or an event conducted around the restaurant.

### Supplementary Note 13

The order support device according to any one of Supplementary Notes 1 to 12, in which
the estimation unit estimates the serving amount of the dish, further based on at least one of a season, a time of day, a day of the week, weather, an air temperature, whether a neighboring facility is open, and traffic conditions.

### Supplementary Note 14

An order support method including:
acquiring reservation information regarding a number of store visitors to a restaurant;
estimating a serving amount of a dish, based on the reservation information;
predicting an amount of an ingredient to be ordered, based on the estimated serving amount of the dish; and
outputting a prediction result on the amount of the ingredient to be ordered.

### Supplementary Note 15

A non-transitory recording medium recording a program for causing a computer to execute:
a process of acquiring reservation information regarding a number of store visitors to a restaurant;
a process of estimating a serving amount of a dish, based on the reservation information;
a process of predicting an amount of an ingredient to be ordered, based on the estimated serving amount of the dish; and
a process of outputting a prediction result on the amount of the ingredient to be ordered.

Some or all of the configurations described in Supplementary Notes 2 to 13 subordinate to above-described Supplementary Note 1 can also be subordinate to Supplementary Notes 14 and 15 with a subordinate relationship similar to that of Supplementary Notes 2 to 13. Some or all of the configurations described as the Supplementary Notes can be similarly subordinate to not only the Supplementary Notes 1, 14, and 15, but also various pieces of hardware and software, a variety of recording means for recording software, and systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An order support device comprising:
at least one memory storing instructions; and
at least one processor configured to access the at least one memory and execute the instructions to:
acquire reservation information regarding a number of store visitors to a restaurant;
estimate a serving amount of a dish, based on the reservation information;
predict an amount of an ingredient to be ordered, based on the estimated serving amount of the dish; and
output a prediction result on the amount of the ingredient to be ordered.

2. The order support device according to claim 1, wherein
the reservation information includes a number of people who have reservations at a facility with the restaurant attached or a number of people who have reservations at the restaurant, and
the at least one processor is further configured to execute the instructions to:
estimate the serving amount of the dish, based on the number of people who have reservations.

3. The order support device according to claim 2, wherein
the reservation information further includes an attribute of a reservation holder at the facility with the restaurant attached or the restaurant, and
the at least one processor is further configured to execute the instructions to:
estimate the serving amount of the dish, based on the number of people who have reservations and the attribute of the reservation holder.

4. The order support device according to claim 1, wherein
the reservation information includes a number of people who have reservations at a facility with the restaurant attached, and further includes at least one of a number of people for each group, a scheduled time of arrival at the facility, scheduled time of stay in the facility, a preference for dishes, a use record of the restaurant, and a physical constitution.

5. The order support device according to claim 4, wherein
the at least one processor is further configured to execute the instructions to:
estimate the serving amount of the dish for each restaurant attached to the facility.

6. The order support device according to claim 5, wherein
the at least one processor is further configured to execute the instructions to:
predict the amount of the ingredient to be ordered, for each restaurant attached to the facility.

7. The order support device according to claim 2, wherein
the reservation information further includes information indicating a style of a seat to be reserved in the restaurant, and
the at least one processor is further configured to execute the instructions to:
estimate the serving amount of the dish, based on the number of people who have reservations and the information indicating the style of the seat.

8. The order support device according to claim 1, wherein
the at least one processor is further configured to execute the instructions to:
estimate the serving amount of the dish, further based on a detection result on a remaining amount of the dish.

9. The order support device according to claim 1, wherein
the at least one processor is further configured to execute the instructions to:
correct an estimated value of the serving amount of the dish, based on a detection result on a remaining amount of the dish served in a buffet-style.

10. The order support device according to claim 8, wherein
the at least one processor is further configured to execute the instructions to:
detect the remaining amount of the dish served in a buffet-style; and
estimate the serving amount of the dish, based on the detected remaining amount of the dish.

11. The order support device according to claim 1, wherein
the at least one processor is further configured to execute the instructions to:
predict the amount of the ingredient to be ordered, further based on a detection result on a remaining amount of the ingredient.

12. The order support device according to claim 1, wherein
the at least one processor is further configured to execute the instructions to:
estimate the serving amount of the dish, further based on an event conducted in a facility with the restaurant attached or the restaurant, or an event conducted around the restaurant.

13. The order support device according to claim 1, wherein
the at least one processor is further configured to execute the instructions to:
estimate the serving amount of the dish, further based on at least one of a season, a time of day, a day of the week, weather, an air temperature, whether a neighboring facility is open, and traffic conditions.

14. An order support method comprising:
acquiring reservation information regarding a number of store visitors to a restaurant;
estimating a serving amount of a dish, based on the reservation information;
predicting an amount of an ingredient to be ordered, based on the estimated serving amount of the dish; and
outputting a prediction result on the amount of the ingredient to be ordered.

15. A non-transitory recording medium recording a program for causing a computer to execute:
a process of acquiring reservation information regarding a number of store visitors to a restaurant;
a process of estimating a serving amount of a dish, based on the reservation information;
a process of predicting an amount of an ingredient to be ordered, based on the estimated serving amount of the dish; and
a process of outputting a prediction result on the amount of the ingredient to be ordered.
